(19) United States
(12) Patent Application Publication
(10) Pub. No.: US 2012/0166008 A1
(43) Pub. Date: Jun. 28, 2012

(54) SMART GRID POWER CONTROLLER AND POWER CONTROL METHOD FOR THE SAME

(75) Inventor: You-Hyeon JEONG, Daejeon-si (KR)

(73) Assignee: Electronics and Telecommunications Research Institute, Daejeon (KR)

(21) Appl. No.: 13/333,402

(22) Filed: Dec. 21, 2011

(30) Foreign Application Priority Data
Dec. 22, 2010 (KR) 10-2010-0132426

(51) Int. Cl. G06F 1/26

(52) U.S. Cl. 700/295

(57) ABSTRACT

There is provided a power controller including a display to display information about electricity supply and demand; a database to store a differentially graded information list listing priorities of electricity supply for a plurality of electric appliances in correspondence to information about electricity supply and demand; a controller to generate a control signal for turning on/off the plurality of electric appliances individually based on the information about the electricity supply and demand and the differentially graded information list; and an interface to receive the information about the electricity supply and demand, to transfer the information about the electricity supply and demand to the display and the controller, and to output the control signal.

### CROSS-REFERENCE TO RELATED APPLICATION

This application claims the benefit under 35 U.S.C. §119(a) of a Korean Patent Application No. 10-2010-0132426, filed on Dec. 22, 2010, the entire disclosure of which is incorporated herein by reference for all purposes.

### BACKGROUND

1. Field

The following description relates to a smart grid power controller and a power control method for the same, and more particularly, to a smart grid power controller capable of differentially supplying electricity to electric appliances according to their importances in order to prevent a power grid from totally stopping supplying electricity or to avoid power outages, and a power control method for the smart grid power controller.

2. Description of the Related Art

Recently, a smart grid technology of applying IT technologies to an electrical power grid has been introduced.

A smart grid, which is an intellectual grid capable of optimizing energy efficiency through bidirectional communication between a power producer and customers, manages and monitors information about the amount of power consumption in real time using smart meters allowing bidirectional communication. Accordingly, using a smart grid allows a power producer who manages a power generation system to effectively determine the amount of electricity supply and demand to guarantee stable supply of electricity.

Also, since the power producer uses such a smart grid to measure the amount of power consumption in real time, it is possible to differentiate electric charges with respect to time. For example, higher electric charges are imposed at peak times of use of electricity, which may lead to a reduction of the amount of electricity consumption, and efficient billing through more accurate measurement on the amount of electricity consumption.

The smart grid technology as described above could acquire information about the amount of power consumption in real time, however, when the amount of electricity consumption exceeds the amount of electricity supply due to occurrence of problems or unexpected power consumption in a power generation system, electricity shortages are caused in customers, such as plants, hospitals, home, etc., and temporal discontinuity of electricity supply at certain places or large-scale power outages occurs, which leads to severe economical expenses.

### SUMMARY

The following description relates to a smart grid power controller of differentially cutting off electric power, thereby preventing large-scale power outages of totally stopping supplying electricity to all customers and guaranteeing stable use of important electric appliances, and a power control method for the smart grid power controller.

In one general aspect, there is provided a power controller including: a display to display information about electricity supply and demand; a database to store a differentially graded information list listing priorities of electricity supply for a plurality of electric appliances in correspondence to information about electricity supply and demand; a controller to generate a control signal for turning on/off the plurality of electric appliances individually based on the information about the electricity supply and demand and the differentially graded information list; and an interface to receive the information about the electricity supply and demand, to transfer the information about the electricity supply and demand to the display and the controller, and to output the control signal.

A smart socket is connected to the interface, and the interface transfers the control signal to the smart socket so as to turn on/off the plurality of electric appliances individually.

A smart meter is connected to the interface, and the amount of power consumption is displayed on the display through the interface.

The power controller includes a power monitoring unit connected to a smart meter, to collect information about the amount of power consumption.

The power controller includes an energy management unit to transfer information about electricity supply and demand in correspondence to the information about the amount of power consumption collected by the power monitoring unit to the interface.

The energy management unit creates the differentially graded information list based on the amount of power supplied from a power generation system and the amount of power consumption totaled by the power monitoring unit.

The energy management unit receives the differentially graded information list from the power controller, and the power controller transfers the amount of power consumption to the energy management unit.

According to another aspect, there is provided a smart grid power control system including: a power monitoring unit to collect information about the amount of power consumption through a plurality of smart meters; an energy management unit to create information about electricity supply and demand based on the information about the amount of power consumption and the amount of power supplied from a power generation system, to store a differentially graded information list for differentially supplying electricity based on the information about the electricity supply and demand, and to generate a differential control signal based on the differentially graded information list; and a power controller to output a control signal for selectively turning on/off a plurality of electric appliances in response to the differential control signal.

The power controller includes: a display to display information about electricity supply and demand; a database to store a differentially graded information list listing priorities of electricity supply for a plurality of electric appliances based on the information about the electricity supply and demand; a controller to generate a control signal for turning on/off the plurality of electric appliances individually based on the information about the electricity supply and demand and the differentially graded information list; and an interface to receive the information about the electricity supply and demand, to output the information about the electricity supply and demand to the display and the controller, and to output the control signal.

The energy management unit is connected to a smart socket to which a plurality of is electric appliances are connected, to control the smart socket to turn on/off the plurality of electric appliances individually.

The energy management unit is connected to multi frequency networks (MFNs) to which a plurality of power controllers are connected, and controls the on/off state of each MFN based on the differentially graded information list.

According to another aspect, there is provided a power control method including: comparing the amount of power supplied from a power generation system with the amount of power consumed by a plurality of electric appliances to create information about electricity supply and demand; and storing a differentially graded information list for differentially supplying electricity to the plurality of electric appliances, and controlling on/off operations of the plurality of electric appliances individually based on the information about electricity supply and demand and the differentially graded information list.

The creating of the information about electricity supply and demand includes creating the information about electricity supply and demand in real time to update the differentially graded information list in real time based on the information about electricity supply and demand.

Also, the controlling of the on/off operations of the plurality of electric appliances includes controlling on/off operations of electric appliances that are currently being used among the plurality of electric appliances based on the information about electricity supply and demand and the differentially graded information list.

The controlling of the on/off operations of the plurality of electric appliances includes controlling a smart socket to selectively supply electricity to the electric appliances.

Therefore, according to the smart grid power controller and the power control system for the same, by selectively supplying electricity when electricity supply is not stable at peak times of electricity consumption or due to failure, etc. of a power generation system or when the amount of power consumption sharply increases unexpectedly, large-scale power outages are prevented and stable use of important equipment at customers is guaranteed.

Other features and aspects will be apparent from the following detailed description, the drawings, and the claims.

### BRIEF DESCRIPTION OF THE DRAWINGS

FIG. 1 is a conceptual view illustrating an example of a smart grid power control system.

FIG. 2 is a diagram illustrating an example of a smart grid power supply system that is used in a customer and an energy management system illustrated in FIG. 1.

FIG. 3 is a diagram illustrating an example of a power controller illustrated in FIG. 2.

FIG. 4 is a flowchart illustrating a power control method for the power controller illustrated in FIG. 2.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

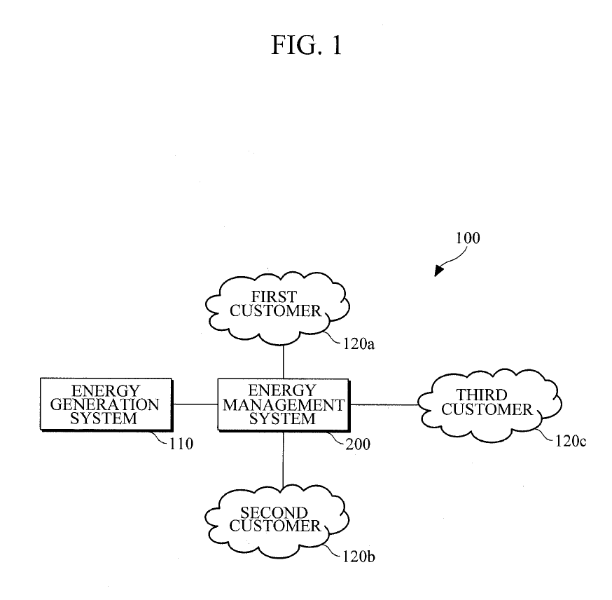

FIG. 1 is a conceptual view illustrating an example of a smart grid power control system 100.

Referring to FIG. 1, the smart grid power control system 100 includes a power generation system 110, a plurality of customers, and an energy management system 200.

The power generation system 110, which is managed by a power producer to generate and supply electricity, generates electricity through power generation equipment, such as a water power plant, a nuclear power plant, a thermal power plant, a tidal energy plant, etc. and supplies the electricity to a plurality of customers. The customers mean power consuming groups, such as home, schools, a plant complex, etc., which use a plurality of electric appliances. For convenience of description, the plurality of customers is assumed to include first, second, and third customers 120a, 120b, and 120c. The first, second, and third customers 120a, 120b, and 120c may receive electricity differentially from the energy management system 200, according to the use purposes of the customers 120a, 120b, and 120c, such as home, a school, a plant complex, etc., and a plurality of electric appliances used in each customer also may receive electricity differentially from the energy management system 200, according to the use purposes of the electric appliances. That is, the plurality of customers 120a, 120b, and 120c selectively receive electricity from the energy management system 200, according to their own use purposes or according to the use purposes of electric applications therein, thereby controlling use of electricity to prevent electricity from being totally cut off and to avoid power outages. To each of the first, second, and third consumers 120a, 120b, and 120c is connected a smart meter, and the smart meter collects information about use of power, and transmits the collected information to the energy management system 200 in real time. Also, the first, second, and third customers 120a, 120b, and 120c may use a plurality of smart electric appliances each of which can transmit information about use of electricity, such as on/off information, etc., to the energy management system 200.

The energy management system 200 controls electricity that is supplied from the power generation system 110 to the plurality of customers 120a, 120b, and 120c. Also, the energy management system 200 compares the amount of power supplied from the power generation system 110 with the amounts of power consumed by the individual customers 120a, 120b, and 120c to supply electricity differentially to the individual customers 120a, 120b, and 120c or to supply electricity differentially to a plurality of electric appliances that use electricity in each of the customers 120a, 120b, and 120c. The energy management system 200 can supply electricity differentially to the plurality of customers 120a, 120b, and 120c or to a plurality of electric appliances that are used in each of the customers 120a, 120b, and 120c, according to the use purposes of the customers 120a, 120b, and 120c or according to the use purposes of the plurality of electric appliances, in order to supply electricity selectively to the plurality of customers 120a, 120b, and 120c or to the plurality of electric appliances when electricity supply is not stable.

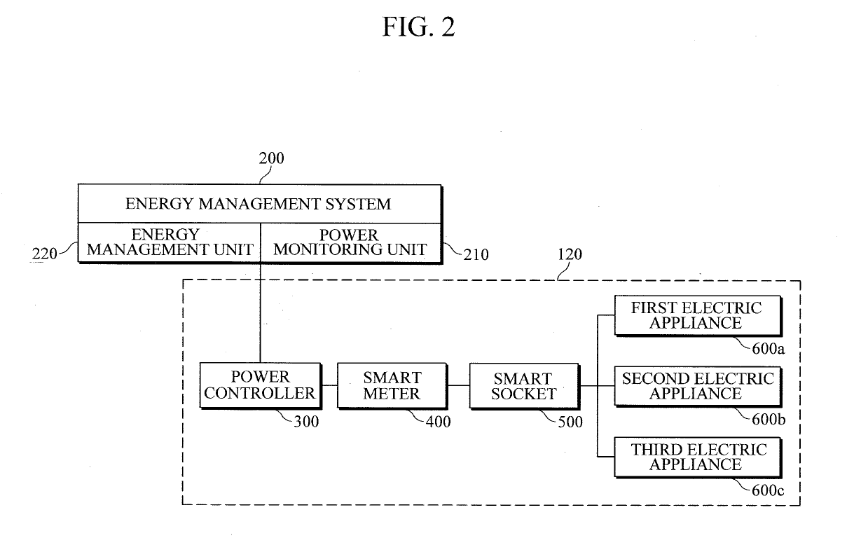

FIG. 2 is a diagram illustrating an example of a smart grid power supply system that is used in the customer 120a and the energy management system 200 illustrated in FIG. 1.

Referring to FIG. 2, the smart grid power supply system includes an energy management system 200, a power controller 300, a smart meter 400, a smart socket 500, and a plurality of electric appliances 600a, 600b, and 600c.

The energy management system 200 includes a power monitoring unit 210 and an energy management unit 220, wherein the power monitoring unit 210 receives information about the amount of power consumption in real time, and the energy management unit 220 determines whether to differentially supply electricity. Particularly, the power monitoring unit 210, which is connected to the power controller 300, receives information about the amount of power consumed by the customer 120a and the amount of power measured by the smart meter 400, is from the power controller 300, in real time, and the energy management unit 220 compares the amount of power consumed by the customer 120a with the amount of power supplied by the power generation system 110 (see FIG. 1) to thus determine whether to differentially supply electricity.

The power controller 300 displays information about the amount of power consumed by the customer 120a and information about electricity supply and demand in real time, thereby determining whether to differentially supply electricity. Also, the power controller 300 includes a differentially graded information list for providing a plurality of electric appliances 600a, 600b, and 600c with differential priorities regarding electricity supply. When the energy management system 200 determines that electricity has to be differentially supplied, the power controller 300 selects one(s) to which electricity has to be supplied from among the electric appliances 600a, 600b, and 600c, based on the differentially graded information list, and supplies electricity only to the selected electric appliances, thereby reducing the amount of power consumption by the customer 120a. That is, the amount of power consumption of the customer 120a is adjusted by the power controller 300.

The power controller 300 may allow the smart socket 500 to supply/cut-off electricity in correspondence to the on-off states of the electric appliances 600a, 600b, and 600c, thereby selectively transferring electricity to the electric appliances 600a, 600b, and 600c connected to the smart socket 500.

The smart meter 400 transfers information about the amount of power consumption to the power controller 300 in real time, and the information about the amount of power consumption is transferred in real time to the energy management system 200.

The smart socket 500 supplies/cuts-off electricity to/from the electric appliances 600a, 600b, and 600c, based on the on-off states of the electric appliances 600a, 600b, and 600c, is thereby preventing electricity from being unnecessarily supplied to the electric appliances 600a, 600b, and 600c.

The electric appliances 600a, 600b, and 600c are smart electric appliances that can output information about the amount of power consumption and information about their on-off states to provide information about whether electricity has to be supplied. The electric appliances 600a, 600b, and 600c include electrical machines that are installed in a plant complex, medical equipment that is used in hospital, and household electronics, and are allocated differential priorities according to their importances, wherein the differential priorities are recorded in the differentially graded information list.

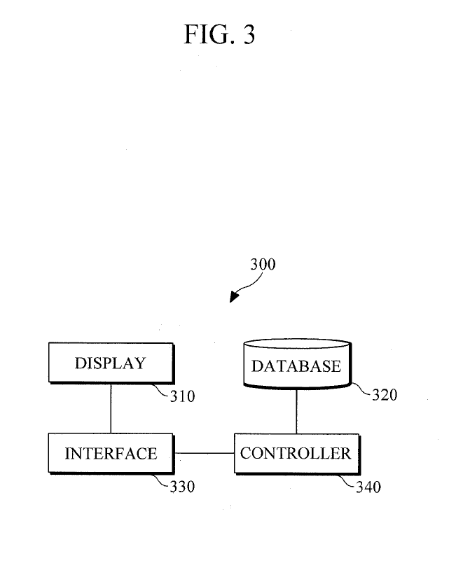

FIG. 3 is a diagram illustrating an example of the power controller 300 illustrated in FIG. 2.

Referring to FIG. 3, the power controller 300 includes a display 310, a database 320, an interface 330, and a controller 340.

Referring to FIGS. 1, 2, and 3, the display 310 displays information about electricity supply and demand, including the amount of power supplied from the power generation system 110 and the amount of power consumption by the electric appliances 120a, 120b, and 120c, in real time. Also, the display 310 displays information received from the energy management system 200 and the smart meter 400.

The database 320 stores a differentially graded information list on which differential priorities of electricity supply with respect to the plurality of electric appliances 600a, 600b, and 600c are recorded. The differentially graded information list is to allocate priorities of electricity supply to the electric appliances 600a, 600b, and 600c in correspondence to their importances in order to classify the electric appliances 600a, 600b, and 600c into ones to which electricity supply must not be stopped and ones to which temporal discontinuity of electricity supply is allowed. Accordingly, when a problem occurs in electricity supply, the power controller 300 distinguishes electric appliances to which electricity has to be supplied from electric appliances to which no electricity needs to be supplied, based on the differentially graded information list, to thus selectively supply electricity to the electric appliances 600a, 600b, and 600c.

The interface 330 transfers information about electricity supply and demand from the controller 340 to the display 310 for the'display 310 to display the information about electricity supply and demand in real time. Also, the interface 330 receives a control signal from the controller 340 and transfers it to the smart socket 500, etc., so as to selectively supply electricity to the electric appliances 600a, 600b, and 600c, thereby reducing the amount of power consumption. In addition, the interface 330 allocates priorities only to electric appliances that are currently being used, except for electric appliances that are currently not used, thereby effectively reducing use of electricity.

The controller 340 receives information about the amount of power supplied from the power generation system 110 and information about the amount of power consumed by the customers 120a, 120b, and 120c, and creates information about electricity supply and demand. Also, the controller 340 generates a control signal using the information about electricity supply and demand.

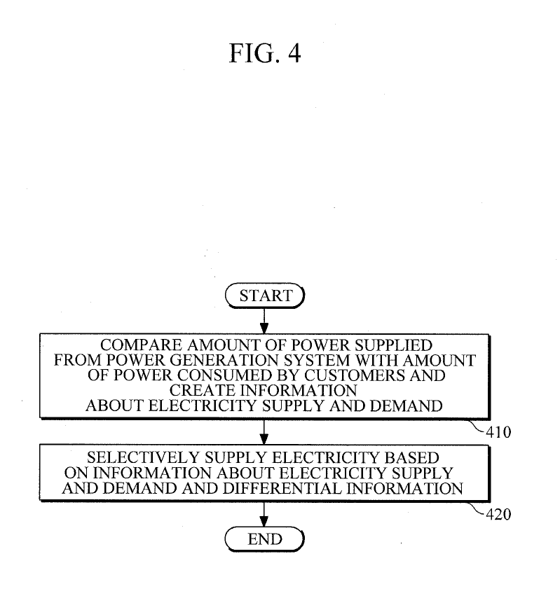

FIG. 4 is a flowchart illustrating a power control method for the power controller 300 illustrated in FIG. 2.

Referring to FIGS. 1 through 4, the power controller 300 recognizes the amount of power consumed by the customers 120a, 120b, and 120c, using the amount of power supplied by the power generation system 110 and the amount of power consumed by the electric appliances, and creates information about electricity supply and demand as a comparison value between the supplied amount of power and the consumed amount of power (410). If the amount of power supplied by the power generation system 110 is less than the amount of power consumed by the electric appliances 600a, 600b, and 600c, the power controller 300 determines that electricity has to be differentially supplied. That is, since the power controller 300 can receive information about the amount of power consumption from the smart meter 400 in real time, the power controller 300 may determine whether to differentially supply electricity in real time. Meanwhile, if the amount of power supplied from the power generation system 110 is more than the amount of power consumed by the electric appliances 600a, 600b, and 600c, the power controller 300 does no longer differentially supply electricity. When it is determined that electricity has to be differentially supplied, the power controller 300 controls the on-off states of the electric appliances 600a, 600b, and 600c individually or selects customers to which electricity has to be supplied to supply electricity only to the selected customers, based on information about electricity supply and demand for differentially supplying electricity to the plurality of electric appliances 600a, 600b, and 600c and differential information for differentially supplying electricity to the individual customers (420). Here, the differential information for differentially supplying electricity is based on a differentially graded information list stored in the database 320 of the power controller 300 or a differentially graded information list stored in the energy management system 200.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations is are within the scope of the following claims.

What is claimed is:

1. A power controller comprising:
a display to display information about electricity supply and demand;
a database to store a differentially graded information list listing priorities of electricity supply for a plurality of electric appliances in correspondence to information about electricity supply and demand;
a controller to generate a control signal for turning on/off the plurality of electric appliances individually based on the information about the electricity supply and demand and the differentially graded information list; and
an interface to receive the information about the electricity supply and demand, to transfer the information about the electricity supply and demand to the display and the controller, and to output the control signal.

2. The power controller of claim 1, wherein a smart socket is connected to the interface, and the interface transfers the control signal to the smart socket so as to turn on/off the plurality of electric appliances individually.

3. The power controller of claim 1, wherein a smart meter is connected to the interface, and the amount of power consumption is displayed on the display through the interface.

4. The power controller of claim 3, further comprising a power monitoring unit connected to the smart meter, to collect information about the amount of power consumption.

5. A smart grid power control system comprising:
a power monitoring unit to collect information about the amount of power consumption through a plurality of smart meters;
an energy management unit to create information about electricity supply and demand based on the information about the amount of power consumption and the amount of power supplied from a power generation system, to store a differentially graded information list for differentially supplying electricity based on the information about the electricity supply and demand, and to generate a differential control signal based on the differentially graded information list; and
a power controller to output a control signal for selectively turning on/off a plurality of electric appliances in response to the differential control signal.

6. The smart grid power control system of claim 5, wherein the power controller comprises:
a display to display information about electricity supply and demand;
a database to store a differentially graded information list listing priorities of electricity supply for a plurality of electric appliances based on the information about the electricity supply and demand;
a controller to generate a control signal for turning on/off the plurality of electric appliances individually based on the information about the electricity supply and demand and the differentially graded information list; and
an interface to receive the information about the electricity supply and demand, to output the information about the electricity supply and demand to the display and the controller, and to output the control signal.

7. The smart grid power control system of claim 5, wherein the power monitoring unit is connected to a plurality of power controllers, and the power controllers are respectively connected to the plurality of smart meters, to collect the amount of power consumption from the plurality of smart meters.

8. The smart grid power control system of claim 5, wherein the energy management unit is connected to a smart socket to which a plurality of electric appliances are connected, to control the smart socket to selectively turn on/off the plurality of electric appliances.

9. The smart grid power control system of claim 5, wherein the energy management unit is connected to a plurality of customers to which a plurality of power controllers are connected, to control whether to supply electricity to each customer based on the differential graded information list.

10. The smart grid power control system of claim 5, wherein the energy management unit creates the differential graded information list based on the amount of power supplied from a power generation system and the amount of consumption power totaled by the power monitoring unit.

11. The smart grid power control system of claim 10, wherein the energy management unit receives the differential graded information list from the power controller, and the power controller transfers the amount of power consumption to the energy management unit.

12. A power control method comprising:
comparing the amount of power supplied from a power generation system with the amount of power consumed by a plurality of electric appliances to create information about electricity supply and demand; and
storing a differentially graded information list for differentially supplying electricity to the plurality of electric appliances, and controlling on/off operations of the plurality of electric appliances individually based on the information about electricity supply and demand and the differentially graded information list.

13. The power control method of claim 12, wherein the creating of the information about electricity supply and demand comprises creating the information about electricity supply and demand in real time and reflecting the information about electricity supply and demand to update the differentially graded information list in real time.

14. The power control method of claim 12, wherein the controlling of the on/off operations of the plurality of electric appliances comprises controlling on/off operations of electric appliances that are currently being used among the plurality of electric appliances based on the information about electricity supply and demand and the differentially graded information list.

15. The power control method of claim 12, wherein the controlling of the on/off operations of the plurality of electric appliances comprises controlling a smart socket to selectively supply electricity to the electric appliances.

16. The power control method of claim 12, wherein the differentially graded information list is created based on the amount of power supplied from the power generation system and the amount of power consumption totaled by the power monitoring unit.
